(19) United States
(12) Patent Application Publication
(10) Pub. No.: US 2008/0158876 A1
(43) Pub. Date: Jul. 3, 2008

(54) HIGH INTENSITY SOLID STATE LIGHTING APPARATUS USING THERMALLY CONDUCTIVE MEMBRANE AND METHOD OF MAKING THERMAL MEMBRANE COMPONENT

(76) Inventor: John E. Thrailkill, Shelburne, VT (US)

Correspondence Address: CESARI AND MCKENNA, LLP, 88 BLACK FALCON AVENUE, BOSTON, MA, 02210, US

(21) Appl. No.: 11/691,868

(22) Filed: Mar. 27, 2007

Related U.S. Application Data
(60) Provisional application No. 60/883,100, filed on Jan. 2, 2007.

(51) Int. Cl. F21V 29/00; B23P 15/26; F21V 7/10

(52) U.S. Cl. 362/235; 29/726

(57) ABSTRACT

A solid state lighting apparatus utilizes a thermally conductive membrane with Light Emitting Diode (LED) die arrays on opposite sides of the membrane as well as a reflecting optical system straddling the thermal membrane and enveloping the LED arrays. The thermal membrane is comprised of a sheet of anisotropic annealed pyrolytic graphite with a central copper via and outer copper frame. These components, after being assembled preliminarily, are plated in copper, or first in copper and then in nickel, as a whole, to provide structural integrity and improved thermal conductivity between the components. The optical system is comprised of a first-surface reflector, either a surface of revolution or compound shape, with foci of reflection that are aligned with the LED arrays on either side of the thermal membrane. Thermal dissipation structures are clamped or bonded to the thermal membrane's outer frame to remove heat from the device. The thermal dissipation structures are configured so as not to impair the operation of the optical system. A method of forming an improved thermal heat-dissipating component is also disclosed.

### CROSS-REFERENCE TO RELATED APPLICATIONS

The present application claims the benefit of U.S. Provisional Patent Application Ser. No. 60/883,100, which was filed on Jan. 2, 2007, by John E. Thrailkill for a HIGH INTENSITY SOLID STATE LIGHTING APPARATUS USING THERMALLY CONDUCTIVE MEMBRANE and is hereby incorporated by reference.

### BACKGROUND OF THE INVENTION

1. Field of the Invention

The present invention relates generally to high intensity, solid state light sources. In particular, the invention relates to a compact light source that utilizes two sided circuit assembly to create a quasi point-source of illumination.

In addition, the present invention generally relates to thermal dissipation devices that enable said light source to operate efficiently. Therefore, the invention also relates, in particular, to the creation of, and a method of creating, a highly thermally conductive membrane assembled from thermally anisotropic annealed pyrolytic graphite and thermally isotropic metallic, or other, materials.

2. Background Information

High intensity light sources are widely used in projection systems, television backlights, automotive headlamps and other devices that require a relatively compact, high output light source. Some applications require a high intensity light source with limited entendue, or solid-angle of light output. For these applications, the light emitting source itself preferably should be as small as possible to achieve the highest efficiencies. Examples of applications that require an illumination source with limited entendue are compact LCD projectors and fiber optic illuminators.

Generally, High Intensity Discharge (HID) lamps have been used due to their high output and high power conversion efficiencies. These devices, however, have the disadvantages of relatively short operating lifetimes, erratic light output vs. time performance, the exhibition of catastrophic failure that can interfere with automatic or man-life dependent operations and high levels of radiated and convected waste heat which can negatively affect the objects of illumination.

As electronic products have become increasingly compact and in many cases more portable, a need has arisen for compact, reliable, solid state illumination sources. These sources, typically based on Light Emitting Diode (LED) technology, offer longer operating lifetimes with more predictable light output vs. time performance, more predictable and manageable failure modes and tunable spectral output. In addition, waste heat is dissipated almost solely as conducted energy. With proper design, conducted waste heat can be dissipated with little or no affect on the object of illumination.

The major shortcoming of the current state of the art for LED technology is the inability to cost effectively produce adequate levels of illumination for high intensity applications.

It is therefore a primary object of the present invention to provide an illumination apparatus that allows for a more concentrated grouping of LED dies than was heretofore possible. The resulting quasi point-source of illumination enables the delivery of optical energy with greater efficiency.

It is a further object of the present invention to provide an illumination apparatus that utilizes a first-surface reflecting optic, in the form of a surface of revolution, or compound shape, to efficiently focus optical energy from the aforementioned quasi point-source of illumination. The present invention is capable of utilizing a variety of reflector configurations to meet a range of illumination requirements.

It is also a primary object of the present invention to provide a thermal dissipation apparatus, working in cooperation with said illumination source, which provides a means of channeling a relatively large amount of waste heat away from the LED die arrays through a relatively thin membrane and out to thermal diffusion structures. This allows the LED die arrays to be mounted on opposite sides of the membrane and in close proximity to each other, creating a quasi point-source of illumination.

It is a further object of the present invention to provide a thermal dissipation apparatus that is efficient enough to allow said LED die arrays to be driven at relatively high power input levels while maintaining adequately low die junction temperatures. Thus, smaller arrays of LED dies can be utilized while delivering sufficient light levels for high intensity applications. With fewer LED dies utilized for a given level of light output, system cost is minimized.

### SUMMARY OF THE INVENTION

By means of the present invention, an apparatus is provided for enhanced light output from solid state LEDs. In addition, an apparatus is provided for enhanced heat removal from the lighting device. In the preferred embodiment of the invention, two LED die arrays are mounted on opposite sides of a relatively thin, thermally conductive membrane. With the separate arrays in close proximity to each other, a quasi point-source of illumination, achieving twice the die placement density of a typical single sided device, is produced. Owing to the minimal thickness of the thermally conductive membrane and the near spherical light output of the back-to-back LED die arrays, a reflecting optical element normally used with point illumination sources, can be employed. These optical elements, being well known to those skilled in the art, are often elliptic or parabolic surfaces of revolution or compound shapes possessing other optical properties.

These reflecting elements offer the advantages of being well understood, reliable, inexpensive and easily configured for a wide range of illumination applications.

To enable densely populated LED die arrays to operate reliably at high power input levels, and in order to minimize the separation between LED die arrays, thereby producing a solid state, quasi point-source of illumination, waste heat is conducted away from the LED light sources through a relatively thin membrane that is constructed of materials that are highly thermally conductive.

In the preferred embodiment described, the membrane is constructed of thermally anisotropic annealed pyrolytic graphite sheet, along with a central thermal via and outer frame constructed from thermally isotropic copper metal. The annealed pyrolytic graphite sheet is highly thermally conductive in the plane of the sheet with considerably lower conductivity in the transverse direction. Therefore, a thermally isotropic conductive via is provided to convey heat from the surface of the membrane, where the LED die arrays are mounted, into the plane of the graphite sheet. Owing to the relatively poor mechanical properties of the graphite material, an outer copper frame completes the assembly. The outer copper frame has greater sectional area to improve thermal spreading to thermal dissipation structures. To assemble the three components and to provide thermal conductivity between them, all components are preferably over-plated in copper as a whole.

With the thermal membrane so constructed, thermal dissipation structures are mechanically assembled or bonded to the membrane for greater thermal diffusion. The thermal dissipation structures also provide the means for mechanical support of the reflecting optics.

In accordance with another embodiment of the invention, a method is disclosed for forming a thermal component useful for dissipating heat generated by an electronic device, such as an array of LEDs, mounted thereon. The method includes the steps of:

(a) providing a relatively thin sheet of thermal material having a pair of opposed major surfaces and a thermal conductivity in the plane of said surfaces that is substantially greater than its thermal conductivity traverse to said surfaces;

(b) forming an opening through said sheet;

(c) preliminarily affixing a metallic via in the opening defined by said sheet;

(d) providing a metallic frame surrounding and supporting said sheet; and

(e) electroplating the above combination as a whole with a metallic layer to add strength and rigidity to the thermal component and to improve the thermal conductivity among the components in the combination.

In the preferred method, the sheet of thermal material is an anisotropic annealed pyrolytic graphite material. Additionally, the electroplating is done using an anisotropic material such as copper as the plated layer.

These and other features will become readily apparent from the following detailed description wherein embodiments of the invention are shown and described by way of illustration. As will be realized, the invention is capable of other and different embodiments and its several details may be capable of modifications in various aspects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

FIG. 1 is a perspective view of a high intensity solid state lighting apparatus in accordance with the present invention;

FIG. 2 is a front view of a high intensity solid state lighting apparatus in accordance with the present invention;

FIG. 3 is an exploded view of a high intensity solid state lighting apparatus in accordance with the present invention;

FIG. 4 is an exploded view of the constituent parts of a thermal membrane structure in accordance with the present invention;

FIG. 5 is a perspective view of a two sided, LED die array and substrate assembly in accordance with the present invention;

FIG. 6 is an exploded view of an LED die array and substrate assembly with optical components in accordance with the present invention.

### DETAILED DESCRIPTION OF AN ILLUSTRATIVE EMBODIMENT

The present invention is generally directed to high intensity solid state light sources. The invention is also directed to thermal dissipation devices that provide efficient operation of said light sources. Additionally, the invention is directed to an improved method of forming a thermal, heat-dissipating component that is light in weight, relatively rigid and robust, and that exhibits improved thermal conductivity.

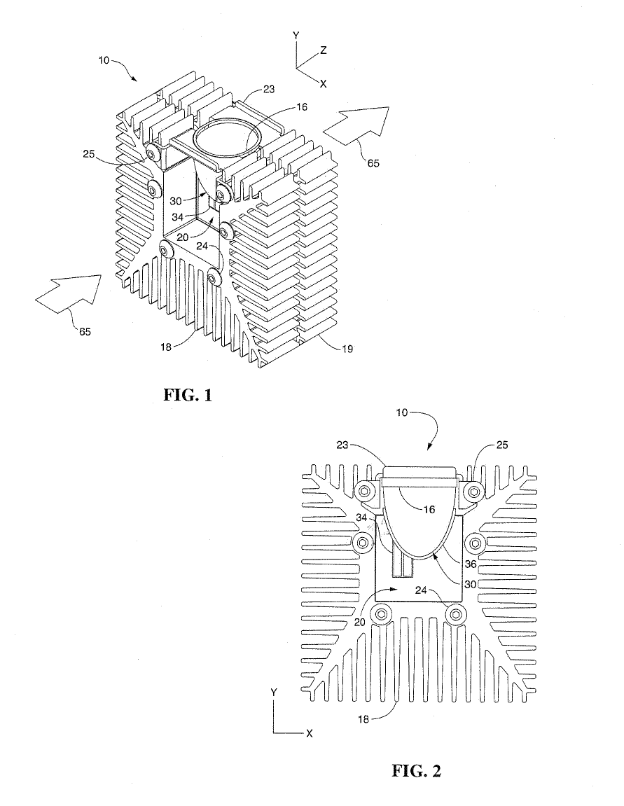

With reference now to the attached drawings, FIGS. 1-3 illustrate a high intensity solid state lighting apparatus 10 in accordance with one or more embodiments of the invention. The lighting system generally includes a two sided, LED die array and substrate assembly 20, a reflecting optic assembly 30 and thermal dissipation structures 18 and 19.

The LED die array and substrate assembly 20 (shown in FIG. 5) includes a thermal membrane component 12, two separate arrays of LED dies 38, with each array being assembled to opposite sides of the thermal membrane component 12 and two printed circuit boards 34, with each printed circuit board being assembled to opposite sides of the thermal membrane component 12.

Each circuit board 34 is attached to the thermal membrane component 12 with an adhesive system, either liquid or tape based. Each circuit board 34 is duly constructed to provide soldering pads for the separate termination of positive and negative wire leads, as supplied by an external power supply device. Each printed circuit board 34 is also duly constructed to provide termination pads that are suitable for wire bond connections to and from the LED arrays.

Wire bonding, an electrical interconnect technology commonly known in the art, is utilized to create electrically conductive circuits within the array of LED die as well as providing electrical connection to and from the printed circuit boards 34.

The present embodiment of the invention utilizes LED dies 38 with top mounted anode and cathode termination pads. In other embodiments, an LED die with a bottom surface anode, known in the art as a vertically structured die, may be employed. Vertical structure refers to the LED dies' electrical current flow from the bottom anode, vertically upward through the device and out to a top mounted cathode termination pad. A lighting apparatus utilizing a vertically structured LED would employ a printed circuit board 34 of a similar but slightly different design known to those skilled in the art.

The LED die arrays 38 presented in the current embodiment consist of four individual LED dies placed adjacent to each other, with said placement resulting in a square array. The LED die are preferably placed as closely to each other as is practical within the limits of the die placement and die attachment processes; however, they are not placed so close as to cause electrical shorting between adjacent die. The thermal 10 membrane component 12 is electrolytically plated with metallic materials, as described further on, so as to enable LED die attachment utilizing a number of different attachment processes commonly known in the art.

The thermal membrane component 12 is comprised of three individual parts, as shown in FIG. 4; a copper frame 13, an anisotropic annealed pyrolytic graphite sheet element 15 and a copper disk, or via 17. The annealed pyrolytic graphite sheet element is preferably that available under the designation TPG® from Momentive Performance Materials (formerly GE Advanced Ceramics), 22557. West Lunn Road, Strongsville, Ohio 44149. In the illustrated embodiment, the sheet element 15 may have dimensions of about 0.9 inches in the X and Y direction and a thickness of about 0.0.3 inches.

To construct the thermal membrane component 12, as provided in the current embodiment, the individual parts are brought together and preliminarily secured to each other in the following manner; the copper disk, or via 17, is brought into an opening within the body of the annealed pyrolytic graphite sheet element 15, with the opening forming a close fit to the outer perimeter of the copper disk, or via 17. The copper disk is centered, in the Z direction (as shown in FIG. 1), within the body of the annealed pyrolytic graphite element 15, such that the exposed planar surfaces of the copper disk, or via 17, are coplanar with the plane of the annealed pyrolytic graphite sheet element, namely, the XY plane, as shown in FIG. 1. The copper disk, or via 17, is subsequently secured to the annealed pyrolytic graphite sheet element 15 by applying an electrically conductive adhesive, at several points, to the surface juncture between the copper disk, or via 17, and the annealed pyrolytic graphite sheet element 15. The adhesion together of these parts is only required for fixturing purposes, that is, until the parts are permanently joined together utilizing an electrolytic plating process, as described below. The electrically conductive adhesive, as provided in the preferred embodiment, is composed of an admixture of copper particles and lacquer. The resulting assembly, comprised of the copper disk, or via 17, and the annealed pyrolytic graphite sheet element 15 is subsequently secured to the copper frame 13 in a like manner as the copper disk, or via 17, and the annealed pyrolytic graphite sheet element 15 were joined together, as previously described.

The copper frame 13, annealed pyrolytic graphite sheet element 15 and copper disk, or via 17, are subsequently permanently joined together by electrolytically plating the assemblage, as a whole, in copper. The plating serves to add mechanical rigidity to the assembly and to insure a high degree of thermal conductivity between the constituent parts. This is achieved by way of the deposition of copper molecules into the physical spaces between the constituent parts. The copper plated assembly is then further plated in nickel, or other suitable metal, in order to attain the correct surface properties for LED die attachment and to produce a photonically reflective surface in order to enhance the efficiency of the lighting apparatus.

It is preferred to construct the thermal membrane component 12 from the three separate parts, namely, the copper frame 13, the annealed pyrolytic graphite sheet element 15 and the copper disk, or via 17, due to the anisotropic thermal property of the annealed pyrolytic graphite sheet element 15. The graphite sheet element possesses the property of being highly thermally conductive in the plane of the sheet (XY plane as shown in FIG. 1) with a minimum thermal conductivity of 1500 watts/m-° C., while exhibiting much lower thermal conductivity, approximately 10-25 watts/m-° C., in the transverse direction (Z direction as shown in FIG. 1). Therefore, the isotropic, thermally conductive copper disk, or via 17, conveys the waste heat emanating from the LED die array 38, where the die array is attached to the surface of the thermal membrane component 12, into the plane of the annealed pyrolytic graphite sheet element 15 from which the waste heat is conducted with high efficiency to the copper frame 13. Owing to the poor mechanical properties of the annealed pyrolytic graphite sheet element 15, the copper frame 13 adds stiffness to the assembly. The copper frame 13 also adds a greater sectional area of thermally isotropic material to the outer extremity of the thermal membrane component 12 in order to improve the thermal spreading of waste heat to the thermal dissipation structures 18 and 19.

A reflecting optic assembly 30 (shown in FIGS. 1-3 and FIG. 6) includes a reflecting optic 14, an optic cover 16 and a gasket 36.

Two LED die arrays 38, being mounted on opposite sides of the relatively thin, thermal membrane component 12, result in a three dimensional array of LED die. The three dimensional LED array achieves twice the LED die placement density of a single sided array while producing a nearly spherical light output pattern during operation the LED arrays thus yield a high intensity, quasi point-source of illumination.

The quasi point-source of illumination enables the present invention to utilize a class of reflecting optics, composed of surfaces of revolution and other compound forms, that are well known in the art.

In the embodiment described, the reflecting optic 14 is a first surface reflector utilizing a compound shape comprised of two physically separated, prolate ellipsoid surfaces and a ruled surface joining them.

The ellipsoid surfaces are separated such that the foci of reflection of the ellipsoid surfaces are made to coincide with the centers of the particular LED die arrays 38 that the foci are assigned to and coacting with.

A variety of other optical reflector designs may be employed to provide a range of illumination solutions. For instance, while the optical design of the present embodiment acts to focus the light emanating from the LED die arrays 38, to a point a short distance from the end of the reflecting optic 14, a different design utilizing a paraboloid shaped reflector could be used to collimate the light, emanating from the LED die arrays 38, in order to illuminate objects a great distance away from the end of the reflecting optic 14.

In a preferred embodiment of the present invention, the reflecting optic 14 is comprised of a single component which can be produced utilizing a number of fabrication processes commonly known in the art. For example, injection molding of engineering plastics can be utilized with an additional metallizing process, machining of various metals can be employed with an additional polishing process and electroforming of various metals can be used to yield a finished part. Appropriate metallizing processes include vacuum metallization utilizing aluminum and electroplating utilizing a variety of metals, depending upon the need.

In another embodiment of the invention, the reflecting optic 14 can be formed through the mating of two separate component halves, such that the components mate along the XY plane as seen in FIG. 1. This design approach possesses the advantage of being able to form component geometries that would be impossible otherwise.

In a preferred embodiment of the present invention, an optic cover 16 (shown in FIG. 6) is composed of a clear plastic material which can be molded or formed from a number of materials, depending upon the need and can be fabricated utilizing a number of processes commonly known in the art. In other embodiments, the optic cover 16 can be molded or formed from glass or fused quartz materials, depending upon the need. The optic cover 16 is fixed in position over the reflecting optic 14 through the use of a pair of optic retention brackets 23 (shown in FIGS. 1-3). The fastening of the optic retention brackets 23 to the thermal dissipation structures 18 and 19 is described below.

In addition to the optic retention brackets 23, other embodiments of the present invention could utilize a variety of devices or processes to further seal or affix the optic cover 16 to the reflecting optic 14. Other devices or processes could include: gaskets, either formed in place with liquid materials or fabricated from sheet stock; adhesives, in the form of a liquid or tape based product; or bonding, through the use of solvents or through the use of various assembly processes, such as ultrasonic welding or spin welding, depending upon the need. To insulate the reflecting optic 14 from the LED die array and substrate assembly 20, a reflecting optic gasket 36 is applied to the LED die array and substrate assembly 20 prior to the mating of the reflecting optic 14 to the substrate assembly. In the illustrated embodiment, the reflecting optic gasket 36 is fabricated from an adhesive backed silicone foam rubber sheet gasket material. Various other sheet gasket materials can be utilized, depending upon the need.

In another embodiment of the present invention, a Room Temperature Vulcanizing (RTV) sealant, or other type of sealant or adhesive system, can be utilized to replace the reflecting optic gasket 36, while providing equivalent function.

Waste heat generated during operation of the LED die arrays 38 is conducted away from said LED arrays by the thermal membrane component 12.

In a preferred embodiment of the present invention, the waste heat is conducted from the thermal membrane component 12 into thermal dissipation structures 18 and 19 (shown in FIGS. 1-3). The structures 18 and 19 are uniquely designed to operate as part of an active, forced convection cooling system, so that a fluid medium, in the present case air, may be forced through the thermal dissipation structures 18 and 19, as indicated by the flow direction arrow 65 (shown in FIG. 1), thereby convectively transferring the aforementioned waste heat into the atmosphere.

The thermal dissipation structures 18 and 19 are preferably fabricated from aluminum utilizing the aluminum extrusion process, a process commonly known in the art. The structures 18 and 19 employ a plurality of radially oriented, thermal dissipation fin structures. The fin structures are specifically designed for a generally radial orientation, whereby multiple secondary fins extend out from each associated base fin.

To provide thermal coupling between the thermal dissipation structures 18 and 19 and the thermal membrane component 12 and to provide overall mechanical rigidity to the high intensity solid state lighting apparatus 10, mechanical fasteners 24 are made to pass through clearance holes in the thermal dissipation structure 18 and into threaded hole features in the thermal dissipation structure 19, trapping the LED die array and substrate assembly 20 between the thermal dissipation structures 18 and 19. Sufficient torque is subsequently applied to the mechanical fasteners 24 in order to minimize thermal resistance between the thermal dissipation structures 18 and 19 and the thermal membrane component 12.

Prior to assembly, in order to aid in the thermal coupling between the thermal dissipation structures 18 and 19 and the thermal membrane component 12, secondary machining operations are performed on the thermal dissipation structures 18 and 19 to create closely matched mating surfaces between the structures and the component.

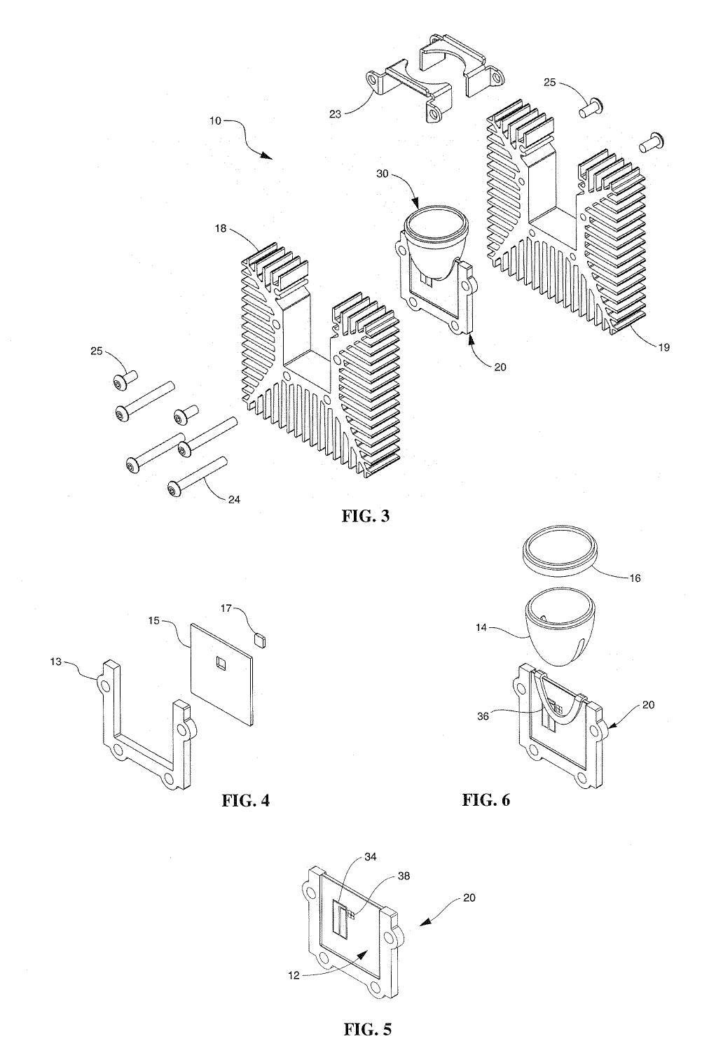

With the thermal dissipation structures 18 and 19 mechanically secured to the LED die array and substrate assembly 20, mechanical fasteners 25 are made to pass through clearance holes located on both sides of the optic retention brackets 23 (shown in FIG. 3) and into threaded hole features in the thermal dissipation structures 18 and 19, thereby mechanically securing the optic retention brackets 23.

In another embodiment of the present invention, the thermal dissipation structures 18 and 19 could be adhesively bonded to the LED die array and substrate assembly 20 with a variety of structural, thermally conductive adhesives commonly known in the art.

In other embodiments of the present invention, a variety of forced convection thermal dissipation structures could be utilized. Other forced convection thermal dissipation structures, commonly known in the art, include bonded fin structures, in which a plurality of thermal dissipation fins, in sheet form, are adhesively bonded or soldered into a plurality of grooves, heretofore cut into a basal structure. Another example of an alternative forced convection thermal dissipation structure is a folded fin structure in which a thin, continuous sheet metal strip is folded repeatedly in a pleat or bellows-like fashion so as to form a continuous series of corrugated fin structures. The folded fin thermal dissipation structure is completed when the corrugated structure is adhesively bonded to a separate basal structure. Yet another example of an alternative forced convection thermal dissipation structure is an injection molded plastic structure in which a thermally conductive polymer compound (e.g. compound of metal particles and thermoplastic polymer) is injection molded to produce a plurality of fin structures and integral basal structure.

As indicated previously, the thermal dissipation structures 18 and 19 described in the preferred embodiment of the present invention are designed to operate as part of an active, forced convection cooling system. A tube axial type fan or centrifugal type blower (not shown), or any other air moving device, possessing sufficient volumetric flow and pressure capability, may be utilized to provide the required airflow, depending upon the need. To maximize the efficiency of the forced convection cooling system, a plenum or duct should be utilized to provide adequate coupling between the air moving device and the thermal dissipation structures 18 and 19.

In other embodiments of the present invention, the thermal dissipation of waste heat from the high intensity solid state lighting apparatus 10 could be achieved by means other than forced convection, as outlined heretofore. Other methods include: liquid cooling, dual phase, closed loop cooling (e.g. heat pipes) and passive convection cooling.

These other means of thermal dissipation are commonly known in the art and are mentioned here so as not to limit the present invention to a single method of thermal dissipation.

What is claimed is:

1. A high intensity solid state lighting apparatus comprising:
a) a relatively thin, thermal membrane component having first and second opposed planar surfaces and a thermal conductivity in the plane of said surfaces that is substantially greater than its thermal conductivity transverse to said surfaces,
b) at least one light emitting diode (LED) mounted on each of said planar surfaces, and
c) an optical reflector for receiving light emitted by said LEDs and reflecting said light into a desired angle of illumination.

2. The lighting apparatus of claim 1 in which said thermal membrane component includes a relatively thin sheet of an anisotropic annealed pyrolytic graphic material.

3. The lighting apparatus of claim 2 in which said sheet of annealed pyrolytic graphic material defines an opening and further including a metallic thermal via fitted in said opening, said LEDs being mounted to opposed sides of said via.

4. The lighting apparatus of claim 3 further including a metallic frame surrounding and supporting said sheet of anisotropic annealed pyrolytic graphic material.

5. The lighting apparatus of claim 4 in which said sheet, said via and said frame are electroplated as a whole with a layer of metallic material.

6. The lighting apparatus of claim 5 in which said electroplated metallic layer is copper.

7. The lighting apparatus of claim 5 further including a layer of nickel electroplated over said copper layer.

8. The lighting apparatus of claim 1 an array of LEDs mounted at opposed positions to each of said planar surfaces.

9. The lighting apparatus of claim 8 in which each LED array includes four LEDs.

10. The lighting apparatus of claim 8 in which said LED arrays include top mounted anode and cathode termination pads.

11. The lighting apparatus of claim 8 in which said LEDs in each array are closely spaced from one another so as to produce a quasi-point source of illumination during periods of operation.

12. The lighting apparatus of claim 1 further including a circuit board mounted to each of said planar surfaces to enable the supply of electrical current to operate said LEDs.

13. The lighting apparatus of claim 1 in which said optical reflector is of a unitary construction which straddles said thermal membrane component and encompasses said LEDs to focus the photonic output of said LEDs.

14. The lighting apparatus of claim 13 in which said optical reflector is comprised of two mirror imaged partial surfaces of revolution separated from each other by a distance equal to the thickness of said thermal membrane component and joined together with a ruled surface, said partial surfaces of revolution being characterized by a cross-sectional curve that is comprised of a quadrant of a prolate elipse.

15. The lighting apparatus of claim 1 further including a pair of thermal dissipation structures affixed to said thermal membrane component, said structures being utilized to dissipate waste heat generated by the LEDs during the LED periods of operation.

16. The lighting apparatus of claim 15, in which each of said thermal dissipation structures comprises a thick basal structure with a plurality of relatively thin fins radiating out from said basal structure.

17. The lighting apparatus of claim 1 in which said optical reflector is comprised of a combination of a ruled surface and partial surfaces of revolution that are characterized by a cross-sectional curve comprised of ½ of a parabola, said curve having an end point at its vertex.

18. The lighting apparatus of claim 1 in which said optical reflector is comprised of a combination of a ruled surface and partial surfaces of revolution that are characterized by a compound cross-sectional curve.

19. The lighting apparatus of claim 1 in which said optical reflector has a two-piece design comprised of two identical reflecting structures each being rotated about a major axis of an ellipsoid relative to each other and thereafter being brought together and affixed together.

20. The lighting apparatus of claim 19 in which the partial surfaces of revolution of said optical reflector are characterized by a compound cross-sectional curve.

21. The lighting apparatus of claim 19 wherein said optical reflector is comprised of a combination of a ruled surface and compound surfaces of varied design.

22. The lighting apparatus of claim 1 wherein said optical reflector has a unitary, solid, construction comprised of a transparent material utilizing the optical principal of total internal reflection to focus the photonic output of said LEDs.

23. The lighting apparatus of claim 22 in which said partial surfaces of revolution of said optical reflector are characterized by a compound cross-sectional curve.

24. The lighting apparatus of claim 22 in which said partial surfaces of revolution of said optical reflector are characterized by a cross-sectional curve comprised of ½ of a parabola with an end point at its vertex.

25. The lighting apparatus of claim 8 wherein each of said LED arrays comprises a square array of four or more LEDs.

26. The lighting apparatus of claim 8 in which said LED arrays are comprised of vertically structured LEDs including an anode located at a bottom surface of each LED and a cathode located on a top surface of each LED.

27. The lighting apparatus of claim 15 in which said thermal dissipation structures are mechanically secured to said thermal membrane component.

28. The lighting apparatus of claim 15 in which said thermal dissipation structures are adhesively bonded to said thermal membrane component using an adhesive that has a relatively high degree of thermal conductivity and structural adhesion.

29. The lighting apparatus of claim 15 in which said thermal dissipation structures are of a bonded thin construction comprised of a plurality of relatively thin sheet metal fins affixed in a plurality of grooves in a relatively thick basal structure.

30. The lighting apparatus of claim 15 in which said thermal dissipation structures are of a folded fin construction comprised of a continuous series of corrugated sheet metal fin structures and a basal structure.

31. The lighting apparatus of claim 15 in which said thermal dissipation structures are injection molded utilizing a thermally conductive polymer compound.

32. A method for forming a thermal component for dissipating heat generated by an electronic device mounted thereon, said method comprising the steps of:
(a) providing a relatively thin sheet of thermal material having a pair of opposed major surfaces and a thermal conductivity in the plane of said surfaces that is substantially greater than its thermal conductivity traverse to said surfaces;
(b) forming an opening through said sheet;
(c) preliminarily affixing a metallic via in the opening defined by said sheet;
(d) providing a metallic frame surrounding and supporting said sheet; and
(e) electroplating the above combination as a whole with a metallic layer to add strength and rigidity to the thermal component.

33. The method of claim 32 in which the thermal membrane component comprises an isotropic annealed pyrolytic graphite sheet material.

34. The method of claim 32 in which the combination of parts as a whole is overplated with copper.

35. The method of claim 34 further including the step of overplating the copper layer as a whole with a layer of nickel.
